(19) United States
(12) Patent Application Publication
(10) Pub. No.: US 2025/0322023 A1
(43) Pub. Date: Oct. 16, 2025

(54) METHODS AND SYSTEMS FOR SPILLOVER FROM COOKIE TO DATABASE

(71) Applicant: Shopify Inc., Ottawa (CA)

(72) Inventor: Colin Bendell, Ottawa (CA)

(21) Appl. No.: 18/893,296

(22) Filed: Sep. 23, 2024

Related U.S. Application Data
(60) Provisional application No. 63/632,306, filed on Apr. 10, 2024.

(51) Int. Cl. G06F 16/957; H04L 9/40

(52) U.S. Cl. CPC G06F 16/9574; H04L 63/0428

(57) ABSTRACT

A data storage and retrieval system for a computer memory associated with a web browser, the data storage and retrieval system comprising a means for configuring the computer memory for storing a browser cookie, the browser cookie including session cookie information, the session cookie information being up to a threshold size; and overflow cookie information, the overflow cookie information including an overflow indication and a database identifier pointing to a database on a server where additional cookie information is stored.

### FIELD OF THE DISCLOSURE

The present disclosure relates to web domains, and in particular relates to cookies for web domains.

### BACKGROUND

A browser cookie, often simply referred to as a “cookie,” is a small piece of data that a website or domain stores on a user's computing device, typically through the web browser. Cookies are used to remember information about the user, their preferences, and their activities on the website. This data is stored in a file and is sent back and forth between the user's browser and the web server each time the browser requests a page from the server.

### SUMMARY

The embodiments of the present disclosure provide for a browser cookie that allows the adding of data to a server-side database once a size threshold has been reached for the cookie.

In one aspect, a data storage and retrieval system for a computer memory associated with a web browser may be provided. The data storage and retrieval system may comprise means for configuring said computer memory for storing a browser cookie. The browser cookie may include session cookie information, the session cookie information being up to a threshold size; and overflow cookie information, the overflow cookie information including an overflow indication and a database identifier pointing to a database on a server where additional cookie information is stored.

In some embodiments, the session cookie information and overflow cookie information may be encrypted, and the browser cookie may further comprise an unencrypted header providing a key identifier for a key used for decrypting the session cookie information and the overflow cookie information.

In some embodiments, the unencrypted header may further include a database location for the key.

In some embodiments, the browser cookie may be compressed.

In some embodiments, the unencrypted header may further comprise an indicator of a compression algorithm used for compression.

In some embodiments, the overflow cookie information may include a decryption key for the additional cookie information stored at the database on the server.

In some embodiments, the overflow cookie information may identify a region for the database on the server.

In some embodiments, information within the browser cookie may be prioritized, and wherein information stored in the session cookie information may have a higher priority than information stored at the database on the server.

In some embodiments, the threshold size may be set for all cookies within the computer memory for a domain.

In a further aspect, a method at a computing device for creating a browser cookie may be provided. The method may include determining that information within a browser cookie exceeds a threshold size and storing a subset of the information within the browser cookie. The method may further include storing a subset of the information in a database on a server and adding overflow information to the browser cookie, the overflow information including an indication and an identifier for the database.

In some embodiments, the subset of information within the browser cookie and overflow information in the browser cookie may be encrypted, and the browser cookie may further comprise an unencrypted header providing a key identifier for a key used for decrypting the subset of information within the browser cookie and the overflow information within the browser cookie.

In some embodiments, the unencrypted header may further include a database location for the key.

In some embodiments, the browser cookie may be compressed.

In some embodiments, the unencrypted header may further comprise an indicator of a compression algorithm used for compression.

In some embodiments, the overflow information may include a decryption key for the subset of the information in the database on the server.

In some embodiments, the overflow information may identify a region for the database on the server.

In some embodiments, information within the browser cookie may be prioritized, and the subset of information stored in the browser cookie may have a higher priority than the subset of information stored in the database on the server.

In some embodiments, the threshold size may be set for all cookies within a computer memory for a domain.

In a further aspect, a computer readable medium for storing instruction code may be provided. The instruction code, when executed by a processor of a computing device, may cause the computing device to configure a computer memory associated with a web browser for storing a browser cookie. The browser cookie may include session cookie information, the session cookie information being up to a threshold size; and overflow cookie information, the overflow cookie information including an overflow indication and a database identifier pointing to a database on a server where additional cookie information is stored.

In some embodiments, the session cookie information and overflow cookie information may be encrypted, the browser cookie may further comprise an unencrypted header providing a key identifier for a key used for decrypting the session cookie information and the overflow cookie information.

In some embodiments, the unencrypted header may further include a database location for the key.

In some embodiments, the browser cookie may be compressed.

In some embodiments, the unencrypted header may further comprise an indicator of a compression algorithm used for the compression.

In some embodiments, the overflow cookie information may include a decryption key for the additional cookie information stored at the database on the server.

In a further aspect, a computer system having at least one processor, a first computer memory associated with a browser, and a second computer memory may be provided. The second computer memory may be configured for storing instructions for configuration of the first computer memory, the instructions providing for storing a browser cookie. The browser cookie may include session cookie information, the session cookie information being up to a threshold size; and overflow cookie information, the overflow cookie information including an overflow indication and a database identifier pointing to a database on a server where additional cookie information is stored.

### BRIEF DESCRIPTION OF THE DRAWINGS

The present disclosure will be better understood with reference to the drawings, in which:

FIG. 1 is a block diagram showing an example plaintext browser cookie with an overflow indication.

FIG. 2 is a block diagram showing an example browser cookie with an overflow indication, where a portion of the browser cookie is encrypted.

FIG. 3 is a dataflow diagram showing the provision of a browser cookie having an overflow indication and the providing of overflow data to a database.

FIG. 4 is a block diagram showing the storage and retrieval of overflow data based on cookies in various regions.

FIG. 5 is a block diagram showing a simplified computing device capable of being used with the embodiments of the present disclosure.

### DETAILED DESCRIPTION

The present disclosure will now be described in detail by describing various illustrative, non-limiting embodiments thereof with reference to the accompanying drawings. The disclosure may, however, be embodied in many different forms and should not be construed as being limited to the illustrative embodiments set forth herein. Rather, the embodiments are provided so that this disclosure will be thorough and will fully convey the concept of the disclosure to those skilled in the art.

HTTP (Hypertext Transfer Protocol) is considered stateless, meaning that each request from a client to a server is independent and unrelated to any previous requests. This statelessness implies that the server does not retain any information about past interactions with a particular client. Once a request is made and a response is sent back, the connection is effectively terminated, and the server does not maintain any knowledge of the client's previous requests or session data. This design simplifies the implementation and scalability of web servers since they do not need to store extensive amounts of information about each client session.

Browser cookies were introduced as a solution to the statelessness of HTTP, allowing websites to maintain some level of state or continuity between requests. Cookies are pieces of data sent from a website and stored in a user's web browser while the user is browsing. They contain information such as user preferences, session identifiers, or other data relevant to the website's functionality. When the user makes subsequent requests to the same website, the browser sends the stored cookies along with the request, enabling the server to recognize the user and maintain continuity across their interactions. Cookies thus provide a way for websites to associate individual requests with user sessions, personalize content, and maintain stateful interactions within the stateless environment of HTTP.

However, in some cases the size of a browser cookie can grow very large. This may be due to the accumulation of data over time. Specifically, as a user interacts with a website, the website may store more and more information within the cookie, potentially causing the browser cookie to grow in size. Also, cookies may grow due to the inclusion of large or complex data structures within the cookie. Specifically, a website in some cases may store user-generated content such as text, images or multimedia files within the cookie.

While the size of a browser cookie for a webpage or web domain does not have a strict maximum, for example defined by a standard, there are practical maximum sizes due to browser implementations and design constraints of underlying network protocol layers. Other network layers and server properties also affect performance of an HTTP Request containing larger and larger cookie payloads. Therefore, while small cookies have little impact on HTTP request performance, large cookies may have a more significant impact.

An alternative to storing data in cookies is to provide a serial number or other session identifier that corresponds to data stored in a server-side database. This however has several downsides, including the database lookup performance and the providing of a Denial of Service (DOS) attack vector, where an attacker can trivially generate new sessions that cause data to be stored server-side. This can lead to a significant server storage resource cost just to store session information.

The embodiments of the present disclosure overcome the issues of large cookies and server-side database retrieval and attack vectors by providing a data storage and retrieval system which provides a cookie that allows the adding of data to a server-side database once a size threshold has been reached for the cookie. Specifically, if there is only a small amount of information to be stored, it can be stored self-contained in the cookie. Conversely, if the amount of information is greater than the threshold, some data can be stored in the cookie along with an identifier indicating there is overflow data in a database, and which database it is in.

This cookie structure overcomes both size constraints, as well as retrieval and DOS attack issues. Specifically, the cookie can be set to a size that is below a threshold, meaning that it will be capable of being attached to each request without causing performance issues, or causing the request to fail (for example based on browser constraints, web server constraints, or intermediate router or computing device constraints).

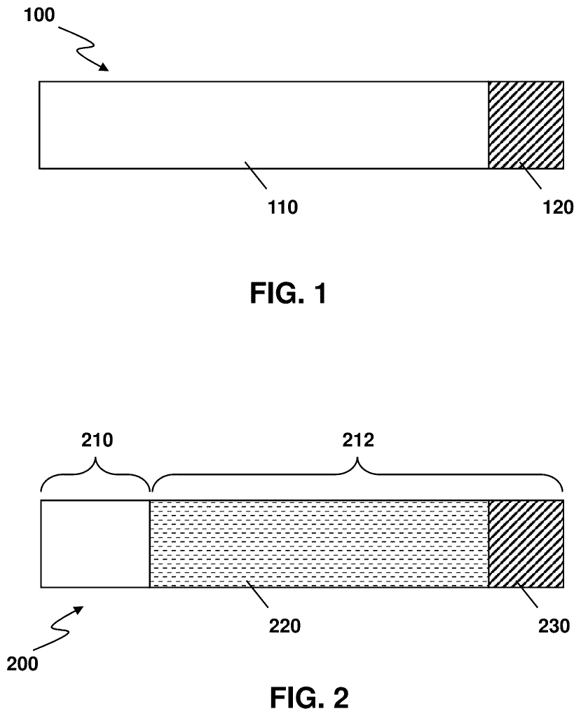

Reference is now made to FIG. 1, which shows an example plaintext browser cookie 100 in accordance with the embodiments of the present disclosure.

In particular, browser cookie 100 contains session cookie information 110. Session cookie information 110 could include any information or subset of information typically found in a cookie, including but not limited to a name for the cookie; a value, which includes the information stored in the cookie; expiration date or time, or a maximum age, indicating when the cookie should be deleted by the browser; a creation timestamp; a domain or subdomain that the cookie is valid for; a path for which the cookie is valid; a secure flag to indicate that the cookie can only be transmitted on HTTP Secure (HTTPS) connections; an Http-Only Flag to prevent access to the cookie at the client, thereby mitigating cross site scripting attacks; and a Same-Site Attribute, which controls when cookies are sent with cross-origin requests.

In some cases, the browser cookie 100 may have User Agent (UA) and a client fingerprint, which may be used for cross-site-request-forgery (CSRF) detection.

The value within the session cookie information can store various data, and can include text, images, or multimedia, and can thus grow to become large. In this regard, according to the embodiments of the present disclosure, an overflow indication 120 may be added to a browser cookie 100 to indicate that additional data for the cookie is stored in a network database. Overflow indication 120 may in some cases be referred to as a spillover indication, an extension indication, among others.

In some embodiments, overflow indication 120 may include a flag or other signal to a web server that the browser cookie 100 has further information stored elsewhere.

Further, overflow indication 120 may provide an identifier for a database that the additional information is stored in. For example, the database identifier may be a Uniform Resource Locator (URL) or other address for the database. The identifier may include a region that the database is located in (e.g. America-East, Europe-Central, YOW1, LHR2). The identifier may include the physical or logical location of the database. Other identifying information for the database may be stored in overflow indication 120.

Further, overflow indication 120 may include a session-key identifier or other identifier used for storage access.

In some cases, data stored in the database may be stored in a different format or schema than data in the session cookie information 110. In this regard, the overflow indication 120 may in some cases store an indicator for the schema or format for the database stored information.

In some cases, data stored in the database may be encrypted. In this regard, the overflow indication 120 may in some cases store a decryption key. This could further ensure privacy of the information in the database, as the web server or other computing device in the network would not be able to decrypt information from the database without the browser cookie 100.

In some cases, data stored in the database may have a pre-amble and an encrypted portion, similar to the cookie described below with regard to FIG. 2.

In some cases, when the data stored in the database is encrypted, the overflow indication 120 could include a key identifier to indicate where to get the decryption key and what key to get. This could be used in situations where, for security, encryption keys are rotated, and thus the correct key to decrypt the data may need to be identified.

In some cases, data stored in the database may be compressed, and the overflow indication 120 may include an indication of the compression algorithm used to compress the data.

Other information may further be stored in the overflow indication 120.

While the embodiment of FIG. 1 shows a plaintext cookie, in some cases parts of the cookie may be encrypted. Reference is now made to FIG. 2, which shows a browser cookie 200.

In the embodiment of FIG. 2, an unencrypted preamble 210 within browser cookie 200 allows retrieval of a decryption key at the server. Such information may include a key identifier in some cases. In some cases, the key identifier may include a location or “region” identifier for the key store. Such key identifier may provide enough information that the server receiving the cookie can find the correct decryption key. Specifically, keys may rotate frequently, and thus the key identifier may identify which key was used at a specific time in the past to allow the browser cookie 200 to be decrypted. This may be useful in situations where a site visitor may have long periods of inactivity, but in which re-authentication may not be possible, such as an electronic commerce application. Because information in the cookie may be sensitive, the keys used for encryption may be changed frequently, but the information may still need to be decrypted after the long period of inactivity. Thus, the key identifier could be used to find the correct decryption key.

In some cases, the key identifier may be a public key significant bit or bits.

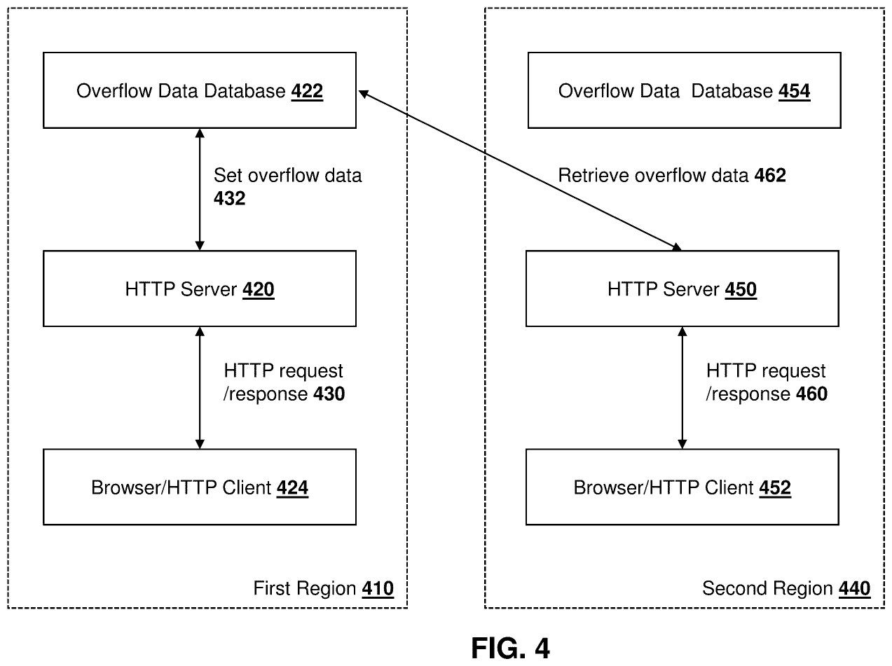

Further, in some cases, the server doing the decrypting may be different from the web server, where the web server may forward the encrypted browser cookie 200 to the decryption server for decryption. This is for example shown in FIG. 4, as described below.

In some cases, the unencrypted preamble may store a compression algorithm identifier to identify how portions of the message are compressed.

In some cases, the unencrypted preamble may have a timestamp the cookie was created at for easy tracking and sorting. In the case of rotating encryption/decryption keys, the timestamp may be used to determine which key was valid at the time of the cookie's creation.

In some cases, metadata on the cookie could form part of the unencrypted preamble. For example, such information may include any information or subset of information typically found in a cookie, including but not limited to a name for the cookie; expiration date or time, or a maximum age, indicating when the cookie should be deleted by the browser; a domain or subdomain that the cookie is valid for; a path for which the cookie is valid; a secure flag to indicate that the cookie can only be transmitted on HTTP Secure (HTTPS) connections; an Http-Only Flag to prevent access to the cookie at the client and therefore mitigating cross site scripting attacks; and a Same-Site Attribute, which controls when cookies are sent with cross-origin requests. Such information may be used by the web browser to determine when the cookie can be sent, and thus may form part of the unencrypted preamble in some cases.

Other information could also form part of the unencrypted preamble.

An encrypted cookie portion 212 may contain information similar to browser cookie 100 from FIG. 1.

In particular, encrypted cookie portion 212 may contain session cookie information 220. Session cookie information 220 could include any information or subset of information typically found in a cookie, and in particular the value field, which includes the information stored in the cookie.

In some cases, the encrypted cookie portion 212 of browser cookie 200 may have User Agent (UA) and a client fingerprint, which may be used for cross-site-request-forgery (CSRF) detection.

The value within the session cookie information can store various data, and can include text, images, or multimedia, and can thus grow to become large. In this regard, according to the embodiments of the present disclosure, an overflow indication 230 may be added to the encrypted cookie portion 212 of browser cookie 200 to indicate that additional data for the cookie is stored in a network database. As with overflow indication 120, overflow indication 230 may in some cases be referred to as a spillover indication, an extension indication, among others.

In some embodiments, overflow indication 230 may include a flag or other signal to a web server that the browser cookie 200 has further information stored elsewhere.

Further, overflow indication 230 may provide an identifier for a database that the additional information is stored in. For example, the identifier may be a URL or other address for the database. The identifier may include a region that the database is located in. However, in some embodiments the region for the database may be the same as the region for a keystore found in the unencrypted preamble 210.

In some cases, the identifier for the database may include a session-key identifier used for storage access.

Other identifying information for the database may be stored in overflow indication 230.

In some cases, data stored in the database may be stored in a different format or schema than data in the session cookie information 220. In this regard, the overflow indication 230 may in some cases store an indicator for the schema or format for the database stored information.

In some cases, data stored in the database may be encrypted using a different key than the key used for encrypted cookie portion 212. In this regard, the overflow indication 230 may in some cases store a decryption key for the particular overflow data in the database associated with browser cookie 200. This could further ensure privacy of the information in the database, as the web server, operator, or other computing device in the network would not be able to decrypt the information from the database without the browser cookie 200.

In some cases, when the data stored in the database is encrypted with a different key than that used for browser cookie 200, the overflow indication 230 could include a key identifier to indicate where to get the decryption key and what key to get.

In some cases, data stored in the database may be compressed. In some cases, this compression may use a different algorithm than one used for browser cookie 200. Thus, the overflow indication 230 may include an indication of the compression algorithm used to compress the data in the database.

In some cases, data stored in the database may have an unencrypted preamble and an encrypted portion, similar to the browser cookie 200.

Other information may further be stored in the overflow indication 230.

Key-value pairs and schema for browser cookie 200 may be enforced using various data formats. One non-limiting example is Protobuf, which is an open source data format used to serialize structured data.

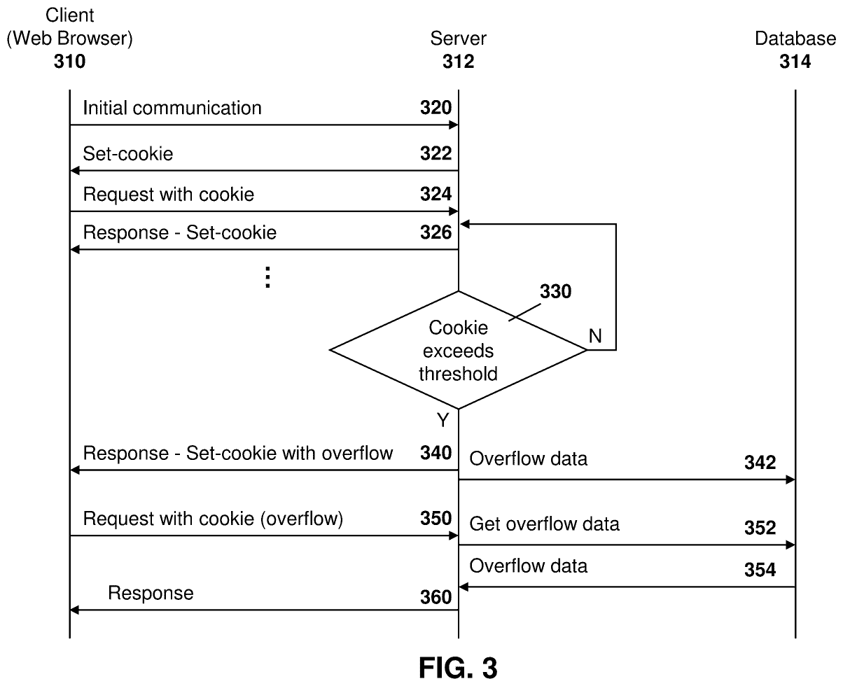

The browser cookies from FIG. 1 and/or FIG. 2 could be used to allow data to overflow to a database once the browser cookie reaches a threshold size. Reference is now made to FIG. 3.

In the example of FIG. 3, a client 310, which may comprise a web browser, may communicate with a server 312. Further, a database 314 may be used to store information or data when a browser cookie reaches a threshold size.

An initial communication from the client 310 to the server 312 is shown with message 320. Such initial communication may be a web request, for example.

Server 312, on receiving the message 320, may provide a response 322. The response 322 may further include a Set-cookie HTTP response header in which an initial cookie is set at the client 310.

Subsequent interactions between client 310 and server 312 could be in the form of requests and responses. The request could include a cookie, as shown with request 324. Specifically, an HTTP Request would typically include the cookie for a domain of server 312, where such cookie is stored by client 310 for the domain.

In response 326, if the server 312 wants to add to the cookie, this may be performed with a Set-cookie HTTP response header, which would cause client 310 to replace the stored cookie with the new cookie received.

In addition, in some cases the server 312 may provide a different cookie that would not be overwritten, but would also be stored at client 310. This would result in subsequent requests to server 312 having multiple cookies.

As will be appreciated by those in the art, during a browser session the size of the cookies needed for Requests could grow. Thus, the server 312 may check whether the cookie(s) for the client 310 exceed a threshold size, as shown by block 330, prior to sending a Set-cookie HTTP response header.

In some cases, such check to determine whether the threshold size has been exceeded may be for a single cookie.

In some cases, when multiple cookies exist, the check may be for the cumulative size of the cookies. Specifically, in some cases, the threshold check can be based on the cumulative size of cookies for a particular domain. If a domain has more than one cookie stored at the client, then the cumulative size of all the cookies for the domain could be used for the threshold check.

When the cookie(s) do not exceed the threshold size, a response such as response to the 326 with a Set-cookie response header having a standard cookie may be sent back to client 310.

When the cookie(s) do exceed the threshold size, the server 312 may create a browser cookie 100 or 200 from FIG. 1 or 2, where the browser cookie 100 or 200 includes an overflow indication and the size of the cookie is limited.

Thereafter, the server could, in response 340, provide the browser cookie 100 or 200 in a Set-cookie HTTP response header to client 310. Further, the server 312 could provide the overflow data to the database 314 with message 342.

In some cases, server 312 may determine which data forms part of the browser cookie and which data forms the overflow data. This may be temporal, where the oldest data may be stored at the database 314 and the newest data may be part of the browser cookie. In some cases, the temporal division may be where the newest data is stored in the database 314 and the oldest data is provided in the browser cookie.

In some cases, server 312 may prioritize data that is needed by the server more frequently to be in the cookie, while data that is less frequently used may be stored in the server-side database 314, reducing data retrieval times. In this case, various prioritization schemes or algorithms can be implemented to classify such data.

Other options for splitting the data between the browser cookie and the overflow data for the database are possible.

Client 310 may subsequently send a request 350 to server 312, where request 350 includes a browser cookie 100 and/or 200 having an overflow indication.

Based on receipt of request 350, server may decide it needs the overflow information, and thus may send a message 352 to database 314 to retrieve the data, and database 314 may return the overflow data in message 354. As will be appreciated by those in the art, the message 352 may be signed by server 312 in some cases to provide system security by only releasing the overflow information to authorized servers.

Based on the received overflow data and the session cookie information from request 350, the server 312 may return a response 360.

When a user stays in a specific region, the processive FIG. 3 may be used to retrieve overflow data. However, in cases where a user moves to a different region, or when Internet routing causes a user to connect to an HTTP server in a different region, among other options, overflow data may need to be obtained from databases in the first region. Reference is now made to FIG. 4 which shows a simplified example of the interaction with HTTP servers in multiple regions.

In the example of FIG. 4, a first region 410 includes an HTTP server 420 and an overflow data database 422. In some cases, overflow data database 422 and HTTP server 420 may be on the same computing device. In some cases, overflow data database 422 and HTTP server 420 may be on the different computing devices.

A user may interact with a browser or other HTTP client 424 within the first region 410.

In this regard, and in accordance with the embodiment of FIG. 3, the client 424 may communicate with server 420, and the server 420 may set cookies in the HTTP request/response messages 430.

When the cookie size reaches a threshold, as described with regard to FIG. 3, the HTTP server 420 may set the overflow data to the overflow data database 422, as shown with message 432. In this regard, the messages 430 may then include cookie(s) with overflow data, as described above.

Thereafter, a user may move to a second region 440, or Internet routing may be routed through a second region 440, among other options. In this case, the browser/HTTP client 452 may interact with HTTP server 450. As will be appreciated by those in the art, the browser/HTTP client 452 would generally be the same as the browser HTTP client 424.

In the example of FIG. 4, an overflow data database 454 exists within the second region 440. In some cases, overflow data database 454 and HTTP server 450 may be on the same computing device. In some cases, overflow data database 454 and HTTP server 450 may be on the different computing devices.

Client 452, when interacting with server 450, may send existing cookies within HTTP request/response messages 460. In this case, the cookies may include an overflow data indication. However, since the overflow data indication also may indicate the region of the database, rather than interacting with database 454, HTTP server 450 may interact with database 422 in order to receive the overflow data, as shown of message 462. In this way, the overflow data that was previously stored in the overflow data database 422 can be retrieved.

Thus, from the embodiments of FIGS. 1 to 4, systems and methods are provided where browser cookies with an overflow indication can be used when the browser cookies reach a threshold size. In this case, overflow data can be stored in a network side database. Benefits of this system include that more basic users with shorter sessions will not have accumulated much session information, and all data will be stored in a cookie. Such users will have little or no database storage burden.

Conversely, users with lengthy or more complex sessions may utilize resources in the database.

Such system prevents a DOS attack vector from simple traffic generating bots by requiring cookie support. Sessions would need to be a certain length before a threshold cookie size is reached, thwarting simple DOS bots without cookie functionality. For example, common DOS or distributed DOS bots do not implement or support cookie functionality. Such “cookie-less” DOS bots do not (and cannot) store cookies to build sessions. Adding such a feature would increase compute/storage/cost for DOS attackers and implementation complexity. Because of this, mounting a DOS attack can be more difficult with the present system, meaning the risk of such attacks may be lessened. For example, as a session cannot be created by a bot without cookie support, the difficulty of mounting a DOS attack targeting session state resources may be lessened.

Conveniently, also, by preferencing storage in cookies over storage in the database, the amount of storage used in the database may be reduced. Indeed, with the present system, not only do a smaller population have data in the database, but those that do have a smaller amount of data. This results in smaller session databases. Conveniently, this may also have benefits in terms of a reduced risk of a DOS attack targeting the database storage: because only clients with associated session data stored in the database even consume backend storage and because the database is only used for storage when cookie storage overflows, absent significant state data, an attacker may experience great difficulty in even triggering consumption of database storage let alone filling the database to the extent of materializing an actual denial of service. Furthermore, to even be able to get to a DOS bot being able to trigger consumption of database space for a session, the DOS bot would need to implement browser cookies (to be able to participate in a session) and thus the difficulty of mounting a DOS attack targeting backend storage is also lessened because of the above-discussed lack of cookie support in conventional DOS bots and the potential difficulties of adding that support to them.

### Computing Device

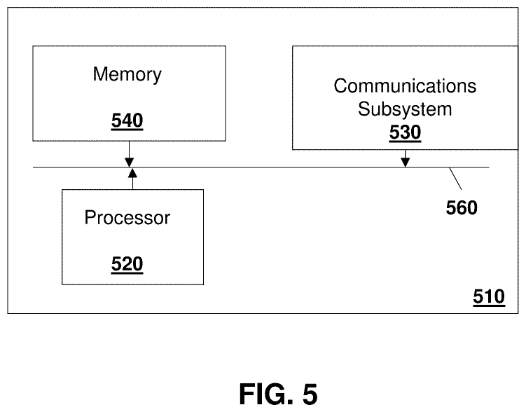

The above-discussed methods are computer-implemented methods and require a computer for their implementation/use. Such computer system could be implemented on any type of, or combination of, network elements or computing devices. This could include web servers; decryption servers; computing devices running browsers; computing devices hosting databases; among others. For example, one simplified computing device that may perform all or parts the embodiments described herein is provided with regard to FIG. 5.

In FIG. 5, computing device 510 includes a processor 520 and a communications subsystem 530, where the processor 520 and communications subsystem 530 cooperate to perform the methods of the embodiments described herein.

The processor 520 is configured to execute programmable logic, which may be stored, along with data, on the computing device 510, and is shown in the example of FIG. 5 as memory 540. The memory 540 can be any tangible, non-transitory computer readable storage medium, such as DRAM, Flash, optical (e.g., Compact Disc (CD), Digital Video Disc (DVD), etc.), magnetic (e.g., tape), flash drive, hard drive, or other memory known in the art. In one embodiment, processor 520 may also be implemented entirely in hardware and not require any stored program to execute logic functions. Memory 540 can store instructions (instruction code), which, when executed by processor 520 cause the computing device 510 to perform the embodiments of the present disclosure. In some cases, memory 540 could be a first computer memory associated with a browser, while when computing device 510 is a server, memory 540 could be a second computer memory at the server used for storing instructions for the configuration of the first computer memory. However, the first memory and second computer memory could in some cases be the same memory. Further, the memory 540, when used for storing browser cookies, may be persisted memory, or may be temporary memory such as Random Access Memory.

Alternatively, or in addition to the memory 540, the computing device 510 may access data or programmable logic from an external storage medium, for example through the communications subsystem 530.

The communications subsystem 530 allows the computing device 510 to communicate with other devices or network elements. In some embodiments, communications subsystem 530 includes receivers or transceivers, including, but not limited to, ethernet, fiber, Universal Serial Bus (USB), cellular radio transceiver, a Wi-Fi transceiver, a Bluetooth transceiver, a Bluetooth low energy transceiver, a Global Positioning System (GPS) receiver, a satellite transceiver, an Infrared Data Association (IrDA) transceiver, among others. As will be appreciated by those in the art, the design of the communications subsystem 530 will depend on the type of communications that the computing device is expected to participate in.

Communications between the various elements of the computing device 510 may be through an internal bus 560 in one embodiment. However, other forms of communication are possible.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above, and combinations thereof may be embodied in computer executable code that, when executing on one or more computing devices, performs the steps thereof. In another aspect, the methods may be embodied in systems that perform the steps thereof and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

1. A data storage and retrieval system for a computer memory associated with a web browser, comprising:
means for configuring said computer memory for storing a browser cookie, said browser cookie including:
session cookie information, the session cookie information being up to a threshold size; and
overflow cookie information, the overflow cookie information including an overflow indication and a database identifier pointing to a database on a server where additional cookie information is stored.

2. The data storage and retrieval system of claim 1, wherein the session cookie information and overflow cookie information are encrypted, the browser cookie further comprising an unencrypted header providing a key identifier for a key used for decrypting the session cookie information and the overflow cookie information.

3. The data storage and retrieval system of claim 2, wherein the unencrypted header further includes a database location for the key.

4. The data storage and retrieval system of claim 2, wherein the browser cookie is compressed.

5. The data storage and retrieval system of claim 4, wherein the unencrypted header further comprises an indicator of a compression algorithm used for compression.

6. The data storage and retrieval system of claim 1, wherein the overflow cookie information includes a decryption key for the additional cookie information stored at the database on the server.

7. The data storage and retrieval system of claim 1, wherein the overflow cookie information identifies a region for the database on the server.

8. The data storage and retrieval system of claim 1, wherein information within the browser cookie is prioritized, and wherein information stored in the session cookie information has a higher priority than information stored at the database on the server.

9. The data storage and retrieval system of claim 1, wherein the threshold size is set for all cookies within the computer memory for a domain.

10. A method at a computing device for creating a browser cookie, the method comprising:
determining that information within a browser cookie exceeds a threshold size;
storing a subset of the information within the browser cookie;
storing a subset of the information in a database on a server; and
adding overflow information to the browser cookie, the overflow information including an indication and an identifier for the database.

11. The method of claim 10, wherein the subset of information within the browser cookie and overflow information in the browser cookie are encrypted, the browser cookie further comprising an unencrypted header providing a key identifier for a key used for decrypting the subset of information within the browser cookie and the overflow information within the browser cookie.

12. The method of claim 11, wherein the unencrypted header further includes a database location for the key.

13. The method of claim 11, wherein the browser cookie is compressed.

14. The method of claim 13, wherein the unencrypted header further comprises an indicator of a compression algorithm used for compression.

15. The method of claim 10, wherein the overflow information includes a decryption key for the subset of the information in the database on the server.

16. The method of claim 10, wherein the overflow information identifies a region for the database on the server.

17. The method of claim 10, wherein information within the browser cookie is prioritized, and wherein the subset of information stored in the browser cookie has a higher priority than the subset of information stored in the database on the server.

18. The method of claim 10, wherein the threshold size is set for all cookies within a computer memory for a domain.

19. A computer readable medium for storing instruction code, which, when executed by a processor of a computing device cause the computing device to:
configure a computer memory associated with a web browser for storing a browser cookie, said browser cookie including:
session cookie information, the session cookie information being up to a threshold size; and
overflow cookie information, the overflow cookie information including an overflow indication and a database identifier pointing to a database on a server where additional cookie information is stored.

20. The computer readable medium of claim 19, wherein the session cookie information and overflow cookie information are encrypted, the browser cookie further comprising an unencrypted header providing a key identifier for a key used for decrypting the session cookie information and the overflow cookie information.
